(19) United States
(12) Patent Application Publication
(10) Pub. No.: US 2025/0217731 A1
(43) Pub. Date: Jul. 3, 2025

(54) NETWORK SYSTEM TO MONITOR ACTIVITIES BASED ON CLIENT-SIDE DATA AND PROGRAMMATICALLY TRIGGER OPERATIONS

(71) Applicant: Uber Technologies, Inc., San Francisco, CA (US)

(72) Inventor: Can Akçevin, San Francisco, CA (US)

(21) Appl. No.: 19/007,350

(22) Filed: Dec. 31, 2024

Related U.S. Application Data
(60) Provisional application No. 63/616,740, filed on Dec. 31, 2023.

(51) Int. Cl. G06Q 10/0631; G06Q 50/47

(52) U.S. Cl. CPC G06Q 10/063112; G06Q 50/47

(57) ABSTRACT

A network system operates to receive, over one or more networks, a transport request from a computing device of a service requester. The network system generates and stores, in a data store, a job order for the transport request. Further, the job order is assigned to a first service provider based on a current location of the first service provider, where the current location is determined based on location information received from a computing device of the first service provider. The network system monitors an activity of the first service provider during a time interval that follows when the first service provider is assigned to the job order. Based on the monitored activity, the network system determines an intent of the first service provider and based on the determination, reassigns the job order.

### RELATED APPLICATION(S)

This application claims benefit of priority to Provisional U.S. Patent Application No. 63/616,740, filed Dec. 31, 2023; the aforementioned priority application being hereby incorporated by reference in its entirety.

### TECHNICAL FIELD

Examples include a network system to remotely monitor activities based on real-time data and programmatically trigger one or more operations in connection with a client device.

### BACKGROUND

On-demand transport services typically match service requesters to service providers. In context of transportation services, the matching processes take into account parameters such as a start location (e.g., pickup location for a rider) and service end location (e.g., the rider's destination). The matching process identifies a service provider for a transport request, but typically the service provider has an option to accept or decline an invitation to fulfill the transport request. Once the service provider accepts the invitation, either service requester or service provider can still cancel the transport request.

### BRIEF DESCRIPTION OF THE DRAWINGS

FIG. 1 illustrates a network system for providing an on-demand transport service, according to one or more embodiments.

FIG. 2 illustrates an example method for monitoring activities of service providers to reduce the occurrence of cancellations, according to one or more embodiments.

FIG. 3 illustrates another example method for monitoring activities of service providers to reduce cancellations, according to one or more embodiments.

FIG. 4 is a block diagram that illustrates a network system for use with one or more embodiments.

FIG. 5 is a block diagram illustrating an example user device for use with examples as described.

### DETAILED DESCRIPTION

Examples includes a network system that provides an on-demand transport service, where the activities of the service provider following the service provider being assigned to a transport request are monitored or evaluated for adequacy of progression by the service provider. The network system can monitor the activity(ies) of the service provider based on data (e.g., timestamps, sensor data, such as bearing information, accelerometer information, or location information determined from a global positioning system receiver, etc.) received, remotely over one or more networks, from a device operated by the service provider. The adequacy of progression on the part of the service provider can be based on, for example, one or more of (i) the service provider's estimated travel time to the start location (e.g., estimated time to arrival for service provider at pickup location); (ii) the route and/or heading taken by the service provider towards the start location; (iii) stoppage by the service provider at a particular location(s) and/or for a duration(s) of time; and/or (iv) detection of the service provider performing an activity that is unrelated to a transport service. The detected activities can be evaluated against a likelihood (e.g., a probability threshold value) that the transport service will be cancelled—either by the service requester (e.g., rider or user) or the service provider (e.g., driver of a vehicle).

If the network system determines that the observed activities of the service provider induces (or is likely to induce) cancellation by the requester, the network system can programmatically implement one or more remediation actions. The remediation action(s) can be directed towards improving the service provider's progression towards a start location and/or preventing cancellation of the transport request by the transport requester and/or performing a rematching process in identifying a new service provider to fulfill the transport request.

As an addition or variation, the network system can determine, based on a programmatically detected activity or behavior of the service provider, as to whether the service provider's intent is to initiate or perform the requested service in accordance with a set of objectives. For example, the network system can make a determination, based at least in part on sensor data received from a device of the service provider or sensor data from a vehicle of the service provider, as to whether the service provider's intent is to progress towards the start location so as to arrive within a given or estimated time interval (e.g., within a threshold time period, such as 1 or 5 minutes, of the arrival time initially indicated to the requester). As additions or variations, the network system can determine whether the service provider's intent is to not progress towards the start location within a set time interval, or whether the service provider intends to cancel the assigned service request altogether.

In examples, the remediation actions taken by the network system can include, for example, sending a notification to a computing device of the service provider to influence, or otherwise cause the service provider to initiate or improve their progression to the service start position. The service provider's response (e.g., activity after the remediation action or activity after input provided on the computing device of the service provider) to the notification can also be similarly evaluated. In examples, the service provider's response can be in the form of a corrective action that improves the service provider's progress. The intention of the service provider to adequately perform the job order can further be inferred based on the response by the service provider to the notification.

In examples, the remediation actions can include automatically adjusting or disassociating the matching or pairing of the service provider with the transport request (and/or the requester) and reassigning that transport request to a different service provider.

Prior to taking a particular remediation action, the network system may make a determination, such as through use of one or more machine-learned models, as to whether the service requester is likely to cancel the transport request. The determination can be based on, for example, the computed amount of delay that presently exist with respect to the estimated time-to-arrival of the service provider to the service start location. The determination can also be based on relevant historical data, such as data that is indicative of the requester's propensity to cancel transport requests (or to cancel transport requests that are late, etc.). The requester's propensity to cancel (e.g., a probability value or score) can be based on, for example, models that are generated through use of machine-based learning, and can be based on the individual requester's historical data and/or other requester's historical data with respect to prior transport requests.

In examples, a network system receives, over one or more networks, a transport request from a computing device of a service requester. The network system generates a job order for the transport request, and assigning the job order to a first service provider based on a current location of the first service provider. Further, the network system monitors an activity of the first service provider during a time interval that follows when the first service provider is assigned to the job order. Based on the monitored activity, the network system determines score that is indicative of an intent of the first service provider to fulfill the job order in accordance with a set of objectives. Based at least in part on the score, the network system reassigns the job order to a different service provider.

Such post-match (or post-acceptance) cancellations can represent a technical burden or cost to the on-demand service in terms of loss efficiency and throughput (e.g., through additional programmatic computations for subsequent matching processes and time delays for users or riders). Examples as described can reduce the occurrence of such post-match or post-acceptance cancellations, thereby reducing the burden on a network system where such transport requests are received. Further, when such cancellations do occur, examples enable the network system to mitigate and lessen the negative impact on the system and the end user.

Among other advantages, examples as described enable a network system to proactively remedy a situation that will likely lead to cancellation of a transport request. Cancellations of transport requests can negatively impact the efficiency of the on-demand service, as additional resources are expended leading up to the cancellation. When a cancellation occurs, a driver is typically redirected, the distance driven by the service provider is wasted, and further computational resources may need to be expended to perform programmatic operations to rematch the requester and/or service provider.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Still further, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### Network System

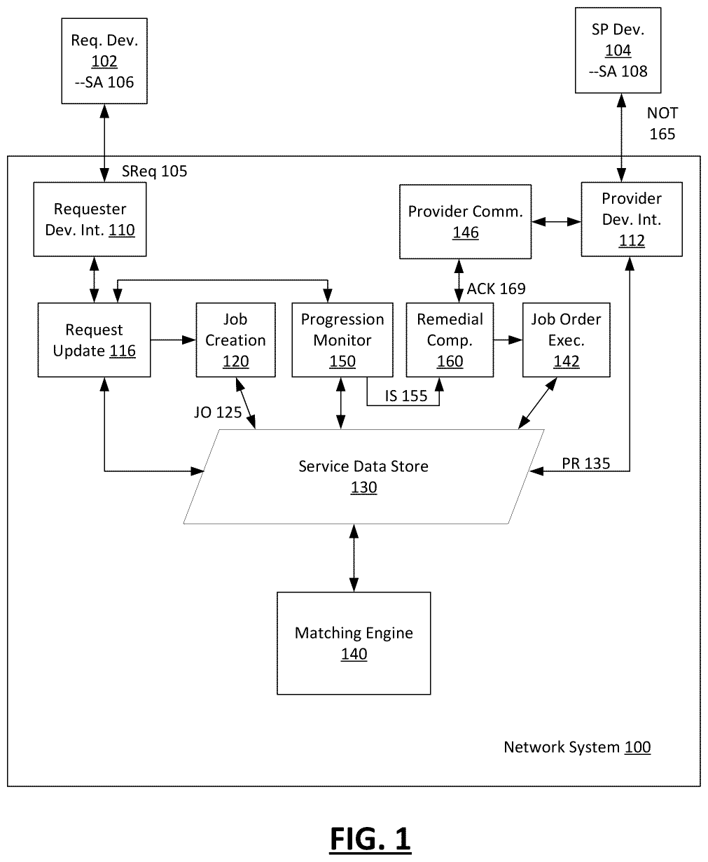

FIG. 1 illustrates a network system for providing an on-demand transport service, according to one or more embodiments. In some examples, a network system 100, as illustrated with FIG. 1, enables a network platform in which users operate mobile computing devices of users access or implement functionality to facilitate the user's participation and use of a matching service. In examples, the users of the network system 100 include service providers (e.g., drivers who operate their own vehicles to transport riders) and requesters (e.g., riders who request and receive transport services from drivers). The transport service provided by the service provider may include a service in which the service provider operates a vehicle to transport the requester from a service start location (e.g., pickup location) to a service end location (e.g., destination or drop-off location). In variations, examples described with the network system 100 can be applied to other types of transport services, such as, for example, group transport (e.g., rider has friends or family who accompany the rider on the trip), pooled transport (e.g., driver picks up additional riders who separately request the transport service, typically with different pickup locations and/or drop-off locations), bus transport (e.g., driver transports multiple riders in large-capacity vehicle, sometimes while following a pre-determined route), or delivery transport (e.g., service provider picks up and delivers an item).

With reference to FIG. 1, the network system 100 executes processes represented by a requester device interface 110, a provider device interface 112, a job creation component 120, a service data store 130, a matching engine 140, a job execution component 142, a progression monitor 150 and a remedial component 160. Each service requester can operate a corresponding requester device 102 to utilize the network system 100. In examples, each requester can operate a service application 106, running on the corresponding requester device 102, to access information, generate service requests and receive services from the network system 100.

Accordingly, in examples, a requester operates service application 106 to transmit a transport request 105 to the network system. The transport request 105 can specify service information, including a service start and a service end location, as well as other information (e.g., time of pickup, if not immediate). The requester device interface 110 receives the transport request 105. The job creation component 120 generates a job order 125 based on the transport request 105. The service data store 130 maintains the job order 125 as a record, where it is updated and used to find matching service providers. The service data store 130 can include a structured data set, such as a database or shard, maintained in cache, in-memory, RAM, etc.

In examples, each job order 125 is associated with a status and with service information. The status of each job order 125 my reflect, for example, whether the job order is “open” (e.g., unassigned to a service provider), initially assigned (e.g., service provider has been assigned, but the service provider has not arrived at the start location), or assigned (e.g., service provider is on-route or has arrived at start location).

A service provider can operate their corresponding service provider device 104 (e.g. using service application 108) to make themself available to the network system 100. Once a service provider makes themselves available (e.g., goes “online”), the provider device interface 112 creates (or updates) a corresponding service provider record 135 that is maintained with the service data store 130. The service provider record 135 can reflect a current location and status of the service provider. Subsequently, the provider device 104 can automatically communicate its current location to the network system 100, using the service application 108, and the service provider record 135 is updated accordingly. In this way, the service provider record 135 can be used to match a service provider with a transport request. Further, after matching, the service provider record 135 can continue to update information about the service provider, such as the status and the current location of the service provider. The status of the service provider can reflect the service provider as being, for example, available (e.g., available to be matched, or unassigned to a transport request).

### Matching Engine

The matching engine 140 implements one or more matching processes to match open transport requests with available service providers. The matching engine 140 can implement the matching process(es) at repeated time intervals (e.g., every 10-, 30- or 60-seconds). In performing the matching, the matching engine 140 can match each open job order 125 with one or multiple available provider records 135, based on factors such as proximity between the start location of the job order 125 and the current location of the available service providers. Once matching is performed for an open job order 125, processes represented by the job execution component 142 can assign a matched service provider to a job order 125. In an example, the job execution component 142 transmits an invitation to a matched service provider, where the invitation identifies the matched job order 125 and additional service information (e.g., expected fare, start location, expected time-to-arrival for service provider to arrive at start location, etc.). The invitation can be communicated via the provider communication component 146. The provider communication component 146 can monitor for a reply communication, where the service provider indicates he or she has accepted or declined the invitation. If the service provider declines the invitation, another service provider can be identified (e.g., through either a prior or upcoming matching process) for purpose of receiving the invitation. If, on the other hand, the service provider responds by accepting the invitation, then the job execution component 142 changes the status of the job order 125 and the corresponding provider record 135 to “assigned”.

As another example, the job execution component 142 can transmit, via the provider communication component 146, a notification to the provider device 104 of the matched service provider, where the notification informs the matched service provider that he has matched to a job order 125. In examples, the notification is sent as an application message or notification for the service application 108 executing on the service provider device. The job execution component 142 can monitor for a reply message that signifies the service provider declines the job order 125. Absent such a communication, the job execution component 142 can update the job order 125 to reflect the automatic assignment of the matched service provider to the job order 125. Likewise, the status of the matched service provider can also be changed to reflect the service provider has been assigned to the job order 125.

Still further, as another example, the matching engine 140 can identify a set of candidate service providers who match to individual job orders 125. The job execution component 142 can provide each service provider of the candidate set with an invitation to accept the job order 125. For example, the job execution component 142 can communicate, via the provider communication component 146, a group invitation to the provider device 104 of each service provider of the candidate set. The provider communication component 146 can monitor for reply communications from the candidate set. The job execution component 142 can select or otherwise determine which of the matched service providers are matched to the job order 125 based on the reply communications. For example, the first service provider to accept the invitation may receive the assignment. The job execution component 142 can determine the assigned service provider and update the job order 125 and respective provider record 135 accordingly.

Once a service provider is assigned to a job order 125, the requester is provided updated information about their transport request. Processes represented by a requester updated 116 can provide the requester device 102 with information about the matched service provider (e.g., service provider rating, name, picture, type of vehicle, etc.), as well as expectations regarding the fulfilment of the transport request. The expectations can include, for example, the estimated time for the service provider to arrive at the start location, and the expected trip completion time (e.g., when the requester is dropped off at the destination). Further, the requester updater 116 can include processes that repeatedly update the requester device 102 regarding a progress of the service provider. For example, the current location, route and/or bearing of the service provider can be indicated on the requester device 102. Further, determinations reflecting the expectations for the trip/service provider, such as the service provider's expected or estimated trip completion time, can be updated based on the progress of the service provider. On the requester device 102, the service application 106 can operate to render information provided by the requester updater 116. The information provided by the requester updater 116 can also include, for example, map content that illustrates a current location, route, and/or heading (or direction of travel) for the assigned service provider. In this way, the requester receives updated information about his or her transport request, including information about the location, route and/or heading of the service provider following the service provider being assigned to the transport request.

Additionally, the job execution component 142 communicates additional information about the assigned job order 125 to the provider device 104. The additional information can include, for example, an expected trip duration, fare amount and distance to be traveled, information about the requester (e.g., requester rating), and/or navigation content to direct the service provider to the start location. The provider device 104 can also receive information indicates a set of expectations. The expectations can include, for example, an estimated service start time, an estimated time-to-arrival for the service provider to reach the start location, and/or an estimated service end time (e.g., when trip should end).

### Activity Monitoring

Once the service provider is assigned to a job order 125, the progression monitor 150 monitors the activity of the service provider. The progression monitor 150 can track the service provider's location information to determine a current location of the service provider, as well as a route or route segment being taken by the service provider, and/or a heading of the service provider. The progression monitor 150 can determine a service provider's route and heading by successively plotting the service provider's location on a map. Further, the location information can identify when the service provider is in a vehicle that is stopped, or when the service provider is outside of the vehicle.

In addition to location information, the progression monitor 150 can receive motion sensor input from the provider device 104. For example, the provider device 104 can transmit motion sensor data generated or based on an accelerometer, gyroscope or inertial mass unit (IMU) of the provider device 104. The progression monitor 150 can use the motion sensor input to determine, for example, whether the service provider is holding, or alternatively, walking while the location of the service provider is stagnant.

In examples, the progression monitor 150 can determine one or more activities of the service provider based on the location information transmitted from the provider device 104. Based on the determined activity of the service provider, the progression monitor 150 can compute a score (“intention score”) that is indicative of an intent of the service provider to fulfill a job order in accordance with a set of objectives (“job order objective(s)”). The intention score may reflect a likelihood or probability that the service provider will perform activities for initiating/fulfilling the job order in accordance with one or more job order objectives. In examples, the job order objectives represent target values for predefined metrics that represent the progress of the service provider towards arriving at the start location. In this regard, a job order objective can represent a target value of a predefined metric (e.g., estimated time-to-arrival at start location), where the target value is deemed to correlate to a probability or likelihood of either the service provider or the requester triggering a cancellation. The failure of the service provider to meet a job order objective can correlate to an increase in the likelihood or probability of job order cancellation, either by the requester cancelling the transport request or by the service provider. As an addition or variation, failure of the service provider to meet a job order objective can correlate to a threshold likelihood or probability of cancellation, initiated by the requester or service provider.

### Route Selection and Monitoring

Based on the location information, the progression monitor 150 can determine the service provider as performing any one of multiple activities. In examples, the progression monitor 150 can determine an activity of the service provider (following assignment to a job order 125) to be that the service provider is traveling on a route or along a bearing. The progression monitor 150 can evaluate the route and/or bearing of the service provider by determining whether the route or bearing of the service provider is appropriate (or inappropriate) with respect to the start location. An appropriate route can correspond to a route that is typically used (e.g., based on historical data), suggested to the service provider (e.g., by the network system 100), optimal (e.g., based on travel time), or otherwise expected of the service provider. Conversely, an inappropriate route can be one that has a bearing that is inconsistent (e.g., in an opposite direction) with the start location, or a route that deviates from an expected or optimal route by more than some threshold value.

The progression monitor 150 can include processes to compare the route the service provider is taking with an expected or optimal route or route profile, and to determine a route deviation based on the comparison. If the determined route deviation is below a threshold, then the activity of the service provider can be determined as the service provider taking an appropriate route to the start location. Likewise, if the determined route deviation is greater than a threshold, then the route taken by the service provider may be deemed inappropriate, and the activity of the service provider may be determined to be traveling on an inappropriate route. In examples, the progression monitor 150 can compare a determined route of the service provider with a route shape or route profile of the start location in order to determine an amount of route deviation (if any) as between the route of the service provider and the shape or profile of the route.

In examples, the progression monitor 150 can associate a job order objective with the route that the service provider travels on at a given time interval following the service provider's assignment to a job order. The job order objective can reflect one or more metrics that categorize the route as appropriate or inappropriate. As an addition or variation, the job order objective can reflect a threshold route deviation score, representing a minimum threshold deviation between the route the service provider is on and the route that the service provider should be on. If the deviation between the route the service provider is taking with one he or she is expected to take exceeds a threshold value, then the progression monitor 150 can deem the route the service provider is taking as inappropriate or anomalous.

The progression monitor 150 can compute the intention score based at least in part on, for example, whether the route the service provider is taking is appropriate or inappropriate, and/or the route deviation score of the route being taken. Depending on implementation, a determination by the progression monitor 150 that the service provider is on an appropriate route can be determinative, or weigh in favor (e.g., reflect a greater intention score) of a determination that the service provider has the intent to fulfill the transport service in accordance with one or more job order objectives (e.g., the service provider taking appropriate route to the start location, etc.). Alternatively, a determination by the progression monitor 150 that the service provider is on an inappropriate or anomalous route can result in a lower intention score, reflecting, for example, a determination that the service provider does not intend to fulfill the service request in accordance with predetermined objectives. Additionally, in examples, if the route deviation is greater than a predetermined threshold (indicating a significant route deviation from an expected route), the progression monitor 150 can determine the intention score to be of a value that reflects a likelihood that either the service provider or requester will cancel the service request.

### Idling

In examples, the progression monitor 150 can use the location information to determine when the service provide is idling. Idling can refer to instances when the service provider has stopped, is stagnant (e.g., slow moving, perturbations in location without overall movement, etc.) or is moving slowly (e.g., below a threshold). In the event the service provider is deemed to be idling, the progression monitor 150 can make additional determinations to determine whether the idling is anomalous. In examples, the progression monitor 150 can determine whether a roadway or segment that the service provider is located on is experiencing traffic congestion. For example, in determining whether the roadway where the service provider is located is experiencing traffic congestion, the progression monitor 150 can (i) compare a speed of the service provider's vehicle (as estimated from location information transmitted from the provider device) with the speed of other vehicles on the same roadway; (ii) determine whether other vehicles on the same roadway or traveling at slow speeds; and/or (iii) check historical information that indicates congestion patters for the particular roadway. If traffic congestion is deemed present, then the idling of the service provider may have no or minimal effect on the intention score of the service provider. If traffic congestion is not deemed present, then the idling (e.g., if exceeds a threshold time interval) can be deemed anomalous.

As an addition or variation, the progression monitor 150 can make the determination as to whether the service provider is stopped in the roadway (e.g., traffic), parked, or outside of the vehicle (e.g., walking) by analyzing movement data provided from the provider device 104, using movement sensor output of the service provider device 104.

In addition to congestion, the progression monitor 150 can utilize additional types of contextual information to determine information about the activity of the service provider. The contextual information can include, for example, points-of-interest near or at the location of the service provider when the service provider is detected to have stopped or slowed. If, for example, congestion is not detected and the service provider's location is static and at or near a POI, the progression monitor 150 can make the inference that the service provider is outside of the vehicle, at the POI. For example, the POI can correspond to a gas station, an electric vehicle charging station, a store, or a favorite location of the service provider (e.g., based on historical information or profile of the service provider).

Following assignment of the progression monitor 150 can compute the intention score based at least in part on, for example, whether or not the idling is anomalous or not. The intention score can reflect, for example, a likelihood that the service provider will be on-route towards the start location within a given interval, and whether the service provider can reach the service start time within an expected arrival time.

### Behavior Modeling

In examples, the progression monitor 150 can also utilize historical information regarding past behavior of the service provider when determining the intention score. For example, historical data regarding the tendency of the service provider to carry out job orders in accordance with job order objectives can be analyzed predict the intent of the service provider in a current time. The historical information can include, for example, the tendency of the service provider to be late on arrival (e.g., instances when the service provider arrived at the service start location past the threshold target time), the tendency of the service provider to engage in idling, past attempts by the service provider to have the requester cancel the transport request, and/or prior instances when the service provider took a circuitous route or detour before pickup. The progression monitor 150 can use models, such as stochastic models, to predict the intention of the service provider and the current assignment.

### Progression Evaluation

As an addition or variation, the progression monitor 150 can evaluate a progress of the service provider towards the start location, once a job order 125 has been assigned to the service provider. In examples, the progression monitor 150 can compute a progress score, reflecting, for example, an adequacy of the service provider's progression towards the start location of the job order. The adequacy of the progression can be determined relative to job order objectives such as the target or threshold arrival time of the service provider at the start location.

In examples, the progression score can be based on job order objectives, such as an objective of the service provider arriving at the service start location within a target time interval. When the service provider is initially assigned to the job order, a determination can be made as to the expected trip time for the service provider to travel to the start location. Based on the expected trip time, the job order 125 can be associated with an expected time-of-arrival for the service provider. Subsequently, the progress of the service provider can be measured in comparison to the expected time-of-arrival for the service provider. For example, the progression monitor 150 can repeatedly determine the estimated time-to-arrival for the service provider based on the service provider's current location and route. The progression monitor 150 can compare the current estimated time-to-arrival with the initial or expected time-of-arrival in order to determine a progress score for the service provider.

Further, the progression determination can reflect instances when the service provider causes a delay in their travel towards the start location. For example, the progression score can reflect instances when the service provider engages in activity such as idling in his or her vehicle, or taking a circuitous route towards the start location.

In examples, the progression monitor 150 can determine an intent of the service provider to fulfill the transport request in accordance with one or more job order objectives, based in part on the progress (e.g., progression score) and activities of the service provider. In examples, the intent of the service provider (e.g., intention score) can be correlated to or otherwise based on the progression of the service provider (e.g., progression score), and/or the activities of the service provider following assignment to a job order 125.

Further, as described in examples below, if the progression monitor 150 determines that the progression of the service provider is not adequate (e.g., progression score is below a threshold), the progression monitor 150 can trigger a notification to be transmitted to the service provider device 104. The notification can prompt the service provider to take action to improve their progress. As an addition or variation, the notification can prompt the service provider to acknowledge the notification through interaction with the provider device 104. In examples, the progression monitor 150 can determine an intention score for the service provider based on the action the service provider takes after receiving the notification (e.g., service provider corrects route to start location, or stops idling, etc.). In variations, the progression monitor 150 can also determine an intention score for the service provider based on an acknowledgement from the service provider.

### Remedial Actions

In examples, the remedial component 160 implements one or more remedial actions based on the intention score 155 computed for the service provider. In examples, the type of remedial actions can include (i) the remedial component 160 initiating transmission, via the provider communication component 146, of a notification 165 to the service provider, and/or (ii) the remedial component 160 initiating a process to reassign the job order 125 to another service provider.

In examples, the remedial action can be selected based at least in part on the intention score 155. In examples, if the intention score is below a first threshold where, for example, the service provider's activity may, if not corrected, run the risk of causing (or increasing the likelihood of causing) the requester to cancel the transport request, then the remedial component 160 can initiate transmission of a notification 165 to the service provider.

In examples, a remedial notification 165 can include content to guide or otherwise influence a service provider's activity in a way that will likely improve the service providers progression. By way of illustration, the notification can state “You seem to be not making progress towards pick up. Head to your pickup as soon as possible.” In variations, the content of the communication can be specific to the service provider and/or the progress the service provider is making. For example, if the service provider is detected as being late to arrive at the start location, the content of the notification 165 can indicate that the service provider is going to be late, how much time the service provider will be late, and/or recommendations for enabling the service provider to mitigate the lack of progress (e.g., the notification may include an alternative route recommendation).

In examples, the notification can inform the service provider that based don their progress or activity, the service provider is in risk of not meeting a job order objective (e.g., the arrival time, traveling on an appropriate route, not idling, etc.). Following delivery of the notification, the progression monitor 150 can monitor the activity of the service provider to determine if the service provider takes corrective action to better meet one or more job order directives. For example, if the notification was sent after the service provider was detected as idling for an extended period, then the progression monitor 150 can monitor the service provider to determine when the service provider stops idling and start progressing towards the start location. The progression monitor 150 can determine the intent (e.g., intention score) of the service provider with respect to fulfilling the transport request based on the activity the service provider performs following receipt of the notification.

In some examples, the notification can be interactive (e.g., user can reply or message back), and the remedial component 160 monitors for a response message 169 (e.g., acknowledgement) from the provider device 104. For example, the notification may be persistent and displayed on the service provider device until the service provider dismisses the notification. Once the notification is dismissed, an acknowledgement is communicated back to the network system 100. The remedial component 160 can implement processes of the provider communication component 146 to detect for the acknowledgement. If the service provider acknowledges the notification, the progression monitor 150 can infer that the notification was read. The subsequent actions of the service provider can be more indicative of the service provider's intent.

### Reassignment

As an addition or variation, if the intention score is below a second threshold, the remedial component 160 can implement a remedial action of initiating driver reassignment. The remedial component 160 can initiate a process where the job order execution component 142 reassigns the job order 125 to a different service provider. In examples, the matching engine 140 can implement a matching process at periodic intervals (e.g. every 10 seconds or every 30 seconds). As a result of the matching process, the job order 125 can be matched to multiple service providers, where one service provider is deemed the primary and other service providers are deemed to be backups. The job order execution component 142 can represent processes that assign matched service providers to job orders 125. The primary service provider can receive an invitation for the job order 125, where the invitation gives the service provider an opportunity to accept or not accept the job order 125. If the service provider does not accept the job order 125, then one of the backup service providers is selected to be the primary service provider who receives the invitation. Once a service provider accepts the invitation, the service provider is assigned to the job order 125. When a determination is made that the driver needs to be reassigned, the job order execution component 142 can implement the reassignment by (i) unassigning the job order 125 from the current matched service provider, and (ii) assigning the job order 125 to the new service provider (e.g., formerly the backup service provider). In some examples, the process of reassignment includes the job order execution component 142 sending an invitation to the backup service provider, and then assigning the job order 125 once that service provider accepts. In some examples, the matching engine 140 continues to match an assigned job order 125 to backup service providers (e.g., every 10 or 30 seconds) until a determination is made that the job order 125 will not be reassigned (e.g., based on intention score, or upon the service provider reaching a threshold distance from the pickup location). In this way, if reassignment is determined by the remedial component 160, the backup service provider that may receive the reassignment is a fresh match.

In variations, the job order execution component 142 can implement reassignment by initiating a new matching process. The job order execution component 142 can implement a matching process to identify, for example, a suitable for the current service provider. Once a suitable replacement is identified, then the current service provider is unassigned to the job order 125, and the new service provider is assigned (or invited to accept) the job order 125.

In some examples, the remedial component 160 makes additional checks before reassigning a job order to a different service provider. If the determination is made that the intention score of the service provider is below a threshold such that reassignment is merited, then in some examples, the remedial component 160 can make additional determinations regarding the intent of the requester. In many cases, a requester can view the service provider activity on the requester device 102—thus of the service provider begins to travel in an opposite direction to the service start location, or is idling for an extended period, the activity may be visible to the requester. Likewise, if the service provider fails to make adequate progress, the estimated time-to-arrival for the service provider may change for the requester. The requester's exposure to the progress and activities of the service provider can induce the requester to cancel the transport request. In particular, the remedial component 160 can include processes that determine the intent of the requester to cancel the transport request at the time reassignment is to take place. If the likelihood of the service provider cancelling the transport request is deemed to exceed a threshold (e.g., more likely than not, 75% likely, etc.), then the remedial component 160 may determine to not reassign the job order 125. Such examples recognize that a failed reassignment has a cost to the service provider. For example, a new service provider may receive the job order, begin travel towards the start location, and upon or near arrival, received the cancellation initiated by the requester. This type of event represents an inefficiency for the second service provider (who was not the cause of the service provider cancelling the transport request). Moreover, both the first and second service providers will have to be re-matched, but from a location that may be near the start location rather than their prior location. To avoid such occurrences, the remedial component 160 can avoid reassignment by determining the requester intent to cancel or not cancel the service request.

The requester's intent can be determined from, for example, (i) the extent to which the service provider will be delayed in arriving at the start location; (ii) the amount of time which is passed since the transport request was first received; (iii) the amount of time which has passed since the job order for the transport request was assigned to the initial service provider; (iv) the degree to which the originally assigned service provider failed to meet one or more job order objectives in parentheses (e.g., the length of time the service provider traveled on an inappropriate route or in the wrong direction); and/or (v) the proximity of the second service provider to the start location.

As an addition or variation, the requester's intention can be specific to the requester and predicted based on one or more machine-learned behavior models. The behavior models can take into account cancellation tendencies of requesters, based on similarity of location, time of day, weather or other context. In further examples, the machine-learned models can take into account the requester's propensity to cancel (e.g., a probability value or score), based on the individual requester's historical data and/or other requester's historical data with respect to prior transport requests. For example, if a requester has previously cancelled a transport request, then the likely intention of the requester may be weighed in favor of the requester cancelling the transport request. Similarly, if past instances exist indicate the requester cancelled the transport request a given time interval after making the request, based on indications that the service provider had failed to meet one or more objectives (e.g., timely arrival), then the predicted intention of the requester may be further weighed in favor of the requester cancelling before the reassigned service provider arrives. If the remedial component 160 predicts, based on the determined intention of the requester, that the requester will cancel the transport request before arrival of the reassigned service provider, then the remedial component 160 may not execute the reassignment.

Additionally, certain rules or limitations can be selected to preclude or weigh against reassignment. As an example, if the originally assigned service provider is within a threshold distance of the start location (e.g., within 1 mile), then the remedial component 160 may not execute a reassignment. As another example, if the backup service provider is further away from the start location as compared to the originally assigned service provider, then the remedial component 160 may not execute the reassignment.

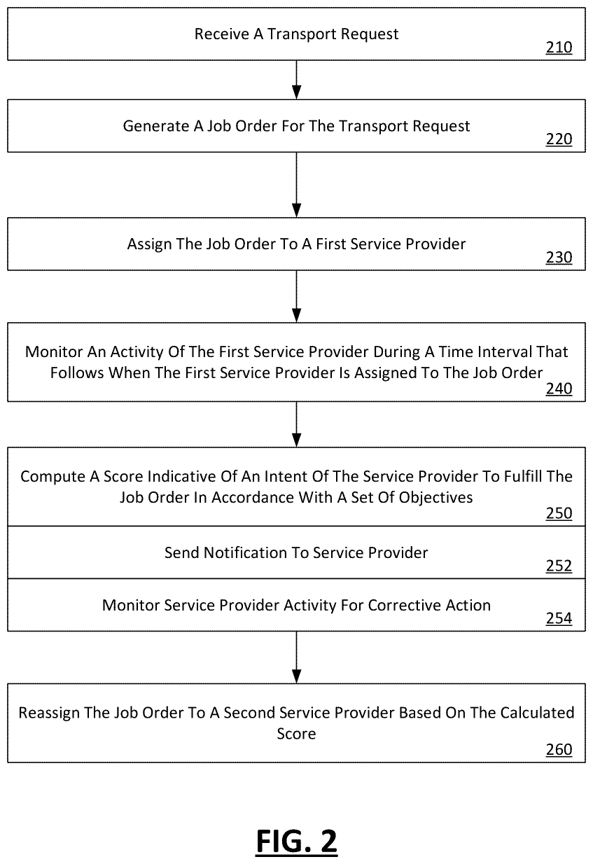

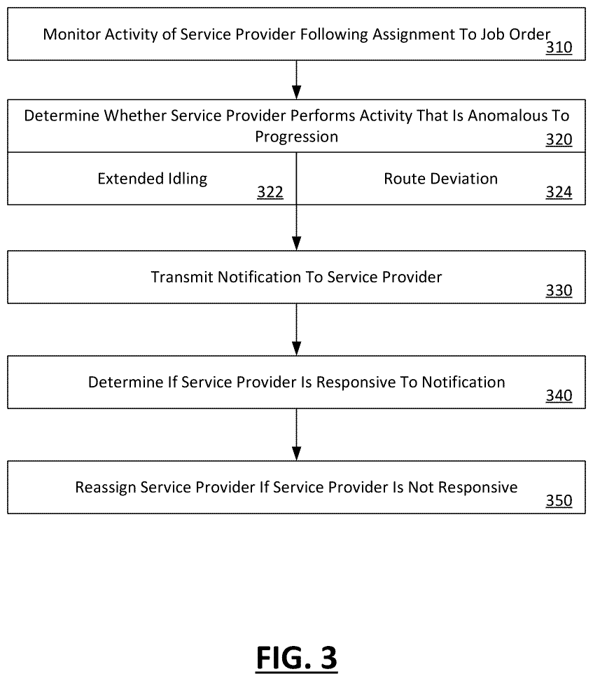

FIG. 2 illustrates an example method for monitoring activities of service providers to reduce the occurrence of cancellations, according to one or more embodiments. FIG. 3 illustrates another example method for monitoring activities of service providers to reduce cancellations, according to one or more embodiments. In describing example methods of FIG. 2 and FIG. 3, reference may be made to elements of FIG. 1 for purpose of illustrating implementation of a step or sub-step being described.

With reference to FIG. 2, in step 210, the network system 100 receives a transport request 105 from the requester. The transport request can specify service information, including one or more service locations. The transport request can be for personal transport, where, for example, a requester is the be picked up from a start location (e.g., pickup location) and driven to a service end location (e.g., destination). In variations, the transport request can be for other types of transport services, such as package delivery.

In step 220, the network system 100 creates a job order for the transport request. In examples, the job order 125 can associate the service information and requester of the transport request with a record that can be maintained and updated by the network system 100.

In step 230, the network system 100 assigns the job order to first service provider. The assignment of the service provider can follow the service provider being matched to the job order 125. In examples, the network system 100 implements one or more matching processes to match individual job orders (or transport requests) with available service providers. The matching process can include matching the job order to multiple service providers, such as a primary service provider and a backup service provider. Alternatively, the matching process can identify multiple service providers who can accept the job order 125 as an assignment. In some examples, a service provider can be assigned to a job order 125 following the service provider being matched to the job order, and then the service provider accepting the job order. In other examples, a group of service providers can be matched to a job order, and one of the service providers in the group can be assigned to the job order 125 after the service provider accepts the job order. Still further, a group of service providers can be matched to a job order, and one of the service providers in the group can be assigned to the job order 125 after multiple service providers accept the job order, with the assignment occurring following a process where one service provider is selected and assigned to the job order 125. Still further, in other examples, a service provider can be matched and automatically assigned to a job order 125.

In step 240, the network system 100 communicates with a provider device 104 to monitor an activity of the service provider during a time interval that follows the service provider being assigned to the job order 125. The monitoring can include the network system 100 receiving and evaluating location information from the provider device 104. The network system 100 can, for example, track the current location of the service provider. Based on the tracking, the network system 100 can determine (i) a route or bearing of travel for the service provider, and (ii) a speed of travel. The network system 100 can analyze location information to determine, for example, whether the service provider is traveling on an appropriate route (e.g., an optimal route, or a route that is in a direction of the start location) or an inappropriate route (e.g., taking a detour for unknown reason, taking a circuitous route, etc.). The network system 100 can also analyze location information to determine when the service provider has stopped, or is traveling below a threshold speed (e.g., below 10 mph).

In variations, the network system 100 can also use sensor data or input generated by movement sensors (e.g., accelerometer, gyroscope, IMU, etc.) of the provider device 104. The network system 100 can also use data from movement sensors to infer an activity of the service provider. For example, the movement sensors can indicate the service provider has braked his vehicle suddenly, or is braking his vehicle repeatedly, implying that the service provider is stopped or moving slowly because of traffic or road event. Still further, the network system 100 can receive information about an activity of the service provider from an operating system of the provider device 104.

In step 250, the network system 100 computes a score (e.g., “intention score 155”) that is indicative of an intent of the service provider to fulfill the job order in accordance with a set of objectives (“job order objectives”). In examples, the determination can correlate to an intent of the service provider to act in a manner that will cause, or make more likely to cause, the service requester to cancel the transport request. Still further, the intention score can correlate to an intent of the service provider to cancel (or induce cancellation) of the job order 125.

In examples, a job order objective can correlate to an activity or outcome that is impactful with regards to inducing a requester cancellation of the transport request. In examples, the job order objectives can reflect metrics that define progression thresholds or milestones, for which if the service provider is unable to meet, the probability of the requester cancelling the service request increases. In examples, the job order objectives can include (i) an objective of the service provider initiating travel towards the start location (“initiation time”) within a first threshold; (ii) an objective of the service provider taking an appropriate route to the start location; (iii) an objective of the service provider not idling or stopping the vehicle for an extended period (when not caused by traffic), and/or (iv) an objective of the service provider arriving at the start location within a threshold arrival time (which can be based on, for example, an expected arrival time for the service provider when the service provider is assigned to the transport request). By way of example, if the requester views on the requester device 102 that the service provider is not on a route towards the pickup location, the service provider may grow impatient and cancel the transport request. Likewise, the requester may also grow impatient if the service provider is viewed as traveling on a poor route towards the pickup location (e.g., requester going through city streets with congestion). Likewise, if the service requester's arrival to the start location is delayed, the requester can cancel the service request.

In examples, the intention score can be based on or correspond to a metric that evaluates an adequacy of the service provider's progress (e.g., progress score). The progress score can reflect or measure an adequacy of the service provider's progress with regards to one or more job order objectives. In examples, the progress score can reflect a timeliness of the service provider with respect to arriving at the start location, where the timeliness can be determined by repeatedly comparing the estimated time-to-arrival for the service provider's current route with an expected or threshold arrival time (which can be determined based on the service provider's location when initially assigned).

In examples, if the intention score is deemed to be below a threshold value, or the service provider is deemed to be making inadequate progress, then in step 252, the network system 100 sends a notification to the service provider, where the notification can guide or otherwise influence a service provider's activity in a way that will likely improve the service providers progress. In examples, the notification can include (i) generic content (e.g., “You seem to be not making progress towards pick up. Head to your pickup as soon as possible.”); or (ii) situational-specific content that is specific to a job order objective that the service provider is not meeting (e.g., “You are traveling on a route that will have you arrive late for pickup. Please correct your route.) As an addition or variation, the notification can include information specific to the job order 125 and service provider activity (e.g., “At this rate, you will be 5 minutes late on arrival at the pickup location. Please check your route.”).

In some examples, the notification can be interactive. In particular, the notification can include interactive features or aspects that are markers of the notification being seen by the service provider.

Following delivery of the notification, in step 254, the network system 100 monitors the service provider activity after sending the notification to determine if the service provider takes corrective action to better meet one or more job order directives. For example, the network system 100 can determine whether after receiving the notification, the service provider changes direction or bearing, changes a current route to a more appropriate route, and/or initiates travel (from idling).

In the case where the notification is interactive, the network system 100 can monitor for acknowledgement that indicates the service provider has read the notification. The activity of the service provider following the acknowledgement can be monitored and evaluated to determine if the service provider has taken corrective action.

In examples, the network system 100 can update or compute the intention score based on the service provider's activity following receipt of the notification. For example, if the service provider takes immediate corrective action, then the intention score can reflect the service provider intends to fulfill the transport request in accordance with the job order objectives. Conversely, if the network system 100 determines that the service provider has not taken corrective action, or adequate corrective action, then the network system 100 computes the intention score to reflect that the service provider does not have the requisite intent to meet the job order objectives.

In examples, the intention score can also include one or more predictive determinations that infer the intent of the service provider with regards to an upcoming time interval (e.g., next 30 seconds). For example, the service provider's intent can be based on one or more machine-learned models that take into account the behavior of the particular service provider, or alternatively, of service provider's in general. Such predictive models can take into account historical data where the same service provider, or more generally, where service providers have canceled, or sought to cancel job orders based on factors such as the service location(s) of the job order (e.g., the pickup location or the destination), the expected time of travel for the service provider, and/or information specific to the requester (e.g., requester with low rating).

In examples, the network system 100 can also determine contextual information when determining the intention score. For example, if the service provider is deemed to be idling, the network system 100 can check for traffic congestion on the road segment where the service provider is located. If congestion is determined to exist, then the determination may mitigate against lowering the intention score when the service provider is idling. Likewise, if the service provider is traveling on a detour or circuitous route, the network system 100 can make a determination as to whether the expected route has traffic congestion, and if traffic congestion is determined to exist, then the route election of the service provider may not impact the intention score.

Based on the computed intention score, in step 260, the network system 100 can reassign the job order 125 to a different service provider. The network system 100 can unassign the current service provider from the job order 125, and then assign a new service provider to the job order 125. In examples, the new service provider is a backup service provider who has already been matched to the job order 125. In some examples, the backup service provider may receive an invitation for the job order 125 before being assigned to the job order. Once the backup service provider accepts the invitation, then the job order is assigned to the backup service provider. In this way, the transition of service providers is seamless to the requester. In this way, the network system 100 can mitigate against an outcome where the service provider cancels the job order 125, or where the service provider behaves in a manner that is likely to induce the requester to cancel the corresponding transport request.

In other examples, a second service provider to take over the job order 125 can be identified through another matching process that is initiated in response to the intention score of the currently assigned service provider. The reassignment can occur if another matched service provider is identified.

In some examples, before the job order is reassigned, a determination is made as to whether the requester is likely to cancel the job order 125, regardless of the change in service providers. The determination can be based on factors that are not specific to the requester-such as the extent of the delay with respect to the service provider arriving at the service start location. In variations, the determination can be based in part on historical information about the requester, such as whether the service provider has previously tolerated delays and/or whether the service provider has previously cancelled service requests.

In some examples, if the determination is that the requester the likelihood of the requester canceling the transport request exceeds a threshold value (e.g., 51% or more probability), then the network system 100 does not perform the reassignment. Otherwise, the network system proceeds with reassigning the job request.

Other rules or logic can also weigh or be determinative as to whether the network system 100 performs the reassignment. In one example, the network system 100 compares distance or time of travel as between the current service provider and the backup service provider (or newly matched service provider) with respect to the service start location. Based on the relative travel distance, the network system 100 may forego performing the reassignment. For example, if the current service provider is closer to the start location than the backup service provider, then the network system 100 may forego reassignment. In variations, if the currently matched service provider is within a threshold distance of the start location, then the network system may also forego reassignment.

With reference to FIG. 3, in step 310, an activity of the service provider may be monitored following the service provider being assigned to a job order 125. The driver activity can be monitored for particular activities that are inconsistent with job order objectives.

In step 320, the network system 100 determines whether the service provider performs an activity that is anomalous to the service provider progressing towards the start location. The network system 100 can repeatedly check for anomalous activities. For example, the network system 100 can check for anomalous activity starting from when the service provider is assigned to the job order 125. In some examples, the network system 100 can check for anomalous activities up until the service provider reaches a threshold distance (e.g., 1 KM) or travel duration (e.g., ETA within 1 minute) from the start location.

In step 322, the anomalous activity can correspond to the service provider being idle for a duration that exceeds a threshold time interval (e.g., X minutes). If such idling is detected, then a determination is made as to whether the idling is the result of traffic congestion. If traffic congestion is deemed to exist, then the idling can be ignored, or rechecked again.

In step 324, the anomalous activity can correspond to the service provider driving in an inappropriate route or direction. The determination can further include the driver driving on the inappropriate route or direction for a threshold time period or distance.

In step 330, the network system 100 transmits a notification to the service provider device 104 to prompt corrective action. The notification can include content that is generic or specific to the anomalous activity. In the latter case, for example, the content of the notification may state “You seem to be idling-Please start traveling to the pickup location,” or “You seem to be driving in the wrong direction from the pickup location-please correct your route.” As described with some examples, the notification can be persistent and interactive, to prompt the user to acknowledge receipt.

Following the notification being sent (or acknowledged), in step 340, the network system 100 determines if the service provider was responsive to the notification. The network system 100 can, for example, determine if the service provider took corrective action to stop the anomalous activity. If the service provider is not responsive, one or more additional notifications may be sent to the service provider.

In step 350, if the service provider does not take corrective action, then the service provider may be unassigned from the job order, and a new service provider (e.g., a backup service provider) may be assigned to the job order 125.

### Hardware Diagram

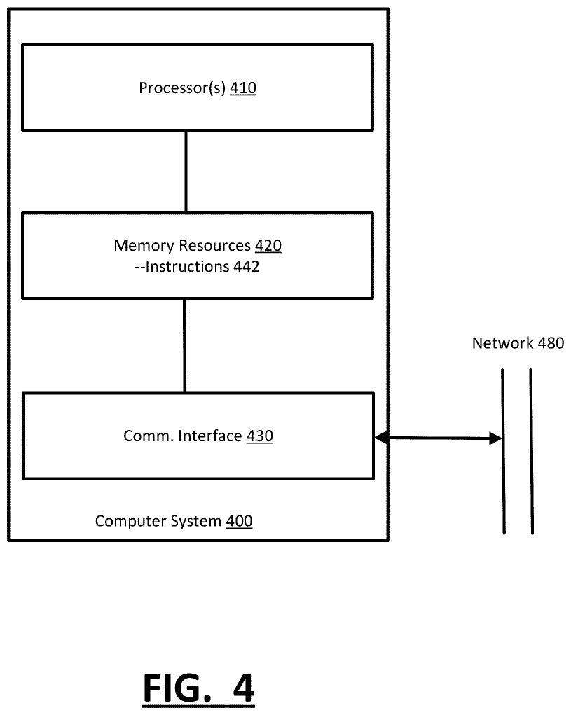

FIG. 4 is a block diagram that illustrates a computer system upon which one or more embodiments described herein may be implemented. For example, in the context of FIG. 1A, the network system 100 may be implemented using a network computer system or combination of network computer systems, such as described with an example of FIG. 4. Additionally, methods such as described with examples of FIG. 2A be implemented using a computer system such as described with an example of FIG. 4.

In one implementation, the computer system 400 includes one or more processors 410, memory resources 420, and a communication interface 430. The computer system 400 includes at least one processor 410 for processing information. The memory resources 420 may include a random-access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 442 for implementing a network system 100, such as described with an example of FIG. 1A. Additionally, the processor(s) 410 can execute the instructions 442 to implement methods such as described with example methods of FIG. 2A.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 400 can receive transport requests from requester devices via the network link 480. Additionally, the computer system 400 can receive information from provider devices, from which forecasts of provisioning levels, location bias and other aspects described herein may be determined.

Examples described herein are related to the use of the computer system 400 for implementing the techniques described herein. According to one embodiment, those techniques are performed by the computer system 400 in response to the processor 410 executing one or more sequences of one or more instructions contained in the memory resources 420. Such instructions may be read into the memory resources 420 from another machine-readable medium, such as the storage device. Execution of the sequences of instructions contained in the memory resources 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### Provider Device

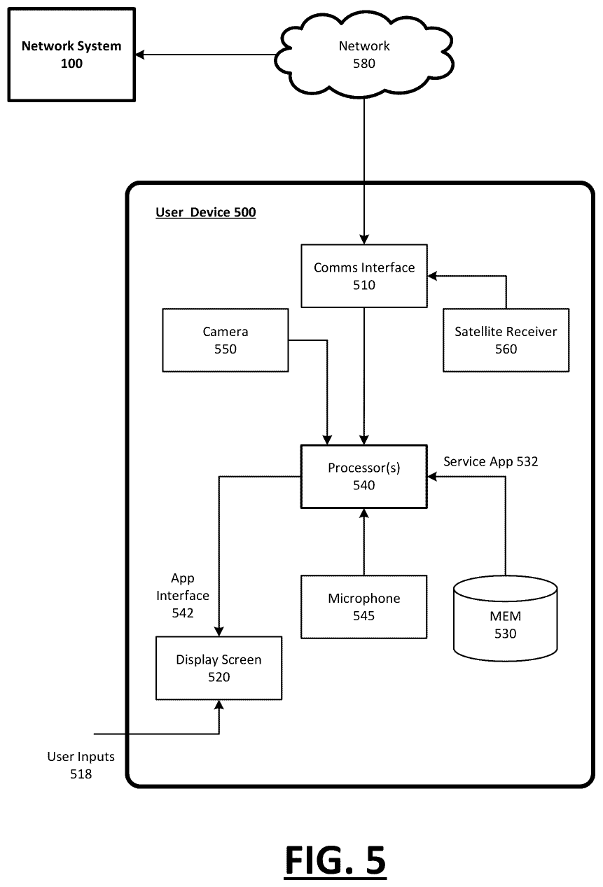

FIG. 5 is a block diagram illustrating an example user device for use with examples as described. In an example, a user device 500 may be implemented as a service provider device 104 that executes a designated service application 108 for use with an on-demand service as provided by a network system 100. In many implementations, a user device 500 can include a mobile computing device, such as a smartphone, tablet computer, laptop computer, VR or AR headset device, and the like. As such, the user device 500 can include typical telephony and/or tablet features such as a microphone 545, a camera 550, a satellite receiver 560, and a communication interface 510 to communicate with external entities using any number of wireless communication protocols. In certain aspects, the user device 500 can store a designated application (e.g., a service app 532) in a local memory 530. In variations, the memory 530 can store additional applications executable by one or more processors 540 of the user device 500, enabling access and interaction with one or more host servers over one or more networks 580.

In response to a user input 518 (e.g., input for cards, input to select response feature), the service application 532 can interact with the user device 500 to display an interface for a multi-modal user interface on the display screen 520. When the user device 500 is used as a requester device, the application executes to provide a multi-modal user interface, with interfaces such as shown with examples of FIG. 3A through FIG. 3S.

### Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A non-transitory computer-readable medium that stores instructions, which when executed by one or more processors of a computer system, cause the computer system to perform operations comprising:
receiving, over one or more networks, a transport request from a computing device of a service requester;
generating, and storing in a data store, data corresponding to a job order for the transport request;
assigning the job order to a first service provider based at least in part on a current location of the first service provider, the current location being determined based on location information received, over the one or more networks, from a computing device of the first service provider;
monitoring, by communicating with the computing device of the first service provider over one or more network, an activity of the first service provider during a time interval that follows when the first service provider is assigned to the job order;
computing a score indicative of an intent of the first service provider to fulfill the job order in accordance with a set of objectives, based at least in part on the monitored activity; and
based at least in part on the score, reassigning the job order to a second service provider.

2. The non-transitory computer readable medium of claim 1, wherein computing the score includes determining whether an estimated time-to-arrival for the first service provider to arrive at a start location is within a threshold time interval.

3. The non-transitory computer-readable medium of claim 1, wherein monitoring an activity of the first service provider includes determining that the first service provider is idling for a duration that exceeds a designated threshold time interval.

4. The non-transitory computer readable medium of claim 3, wherein computing the score includes determining whether traffic congestion is present when the first service provider is idling.

5. The non-transitory computer-readable medium of claim 3, wherein computing the score includes:
in response to determining that the first service provider is idling for the duration that exceeds the designated threshold time interval, transmitting, over one or more networks, a notification to the computing device of the first service provider; and
monitoring an activity of the first service provider after receiving the notification to determine whether the first service provider stops idling and begins to make progress towards a start location of the job order.

6. The non-transitory computer readable medium of claim 1, wherein monitoring an activity of the first service provider includes determining that the first service provider is traveling on a route or bearing that is inappropriate for a start location of the job order.

7. The non-transitory computer-readable medium of claim 6, wherein computing the score includes:
in response to determining that the first service provider is traveling on the route or bearing that is inappropriate for the start location of the job order, transmitting, over one or more networks, a notification to the computing device of the first service provider; and
monitoring an activity of the first service provider after receiving the notification to determine whether the first service provider takes an appropriate route or direction towards the start location.

8. The non-transitory computer-readable medium of claim 1, wherein monitoring the activity of the first service provider includes determining a progress of the first service provider towards a start location of the transport request.

9. The non-transitory computer-readable medium of claim 8, wherein computing the score includes:
determining that the progress of the first service provider is inadequate based on one or more of the set of objectives, and in response to making the determination, transmitting, over one or more networks, a notification to the computing device of the first service provider.

10. The non-transitory computer-readable medium of claim 9, wherein computing the score includes:
monitoring an activity of the first service provider after transmitting the notification; and
determining, based on the monitoring, whether the first service provider has taken a corrective action.

11. The non-transitory computer-readable medium of claim 1, wherein reassigning the job order includes determining that a likelihood of the service requester cancelling the transport request is less than a threshold.

12. The non-transitory computer-readable medium of claim 1, wherein reassigning the job order includes determining that the second service provider is closer to a start location of the job order.

13. The non-transitory computer-readable medium of claim 1, wherein monitoring the activity of the first service provider is based on sensor data from one or more movement sensors of the computing device of the provider.

14. A network computer system comprising:
one or more processors;
a memory to store a set of instructions;
wherein the one or more processors execute instructions to perform operations that include:
receiving, over one or more networks, a transport request from a computing device of a service requester;
generating, and storing in a data store, data corresponding to a job order for the transport request;
assigning the job order to a first service provider based at least in part on a current location of the first service provider, the current location being determined based on location information received, over the one or more networks, from a computing device of the first service provider;
monitoring, by communicating with the computing device of the first service provider over one or more network, an activity of the first service provider during a time interval that follows when the first service provider is assigned to the job order;
computing a score indicative of an intent of the first service provider to fulfill the job order in accordance with a set of objectives, based at least in part on the monitored activity; and
based at least in part on the score, reassigning the job order to a second service provider.

15. The network computer system of claim 14, wherein computing the score includes determining whether an estimated time-to-arrival for the first service provider to arrive at a start location is within a threshold time interval.

16. The network computer system of claim 14, wherein monitoring an activity of the first service provider includes determining that the first service provider is idling for a duration that exceeds a designated threshold time interval.

17. The network computer system of claim 16, wherein computing the score includes determining whether traffic congestion is present when the first service provider is idling.

18. The non-transitory computer-readable medium of claim 16, wherein computing the score includes:
in response to determining that the first service provider is idling for the duration that exceeds the designated threshold time interval, transmitting, over one or more networks, a notification to the computing device of the first service provider; and
monitoring an activity of the first service provider after receiving the notification to determine whether the first service provider stops idling and begins to make progress towards a start location of the job order.

19. The network computer system of claim of claim 16, wherein monitoring an activity of the first service provider includes determining that the first service provider is traveling on a route or bearing that is inappropriate for a start location of the job order.

20. A computer-implemented method comprising:
receiving, over one or more networks, a transport request from a computing device of a service requester;
generating, and storing in a data store, data corresponding to a job order for the transport request;
assigning the job order to a first service provider based at least in part on a current location of the first service provider, the current location being determined based on location information received, over the one or more networks, from a computing device of the first service provider;
monitoring, by communicating with a computing device of the first service provider over one or more network, an activity of the first service provider during a time interval that follows when the first service provider is assigned to the job order;
computing a score indicative of an intent of the first service provider to fulfill the job order in accordance with a set of objectives, based at least in part on the monitored activity; and
based at least in part on the score, reassigning the job order to a second service provider.
